(19) United States
(12) Patent Application Publication
(10) Pub. No.: US 2014/0324600 A1
(43) Pub. Date: Oct. 30, 2014

(54) Method for Monetization of Avatar Customization on a Web Site

(71) Applicant: Yessenia L. Soffin, Malibu, CA (US)

(72) Inventor: Yessenia L. Soffin, Malibu, CA (US)

(21) Appl. No.: 14/046,619

(22) Filed: Oct. 4, 2013

Related U.S. Application Data
(60) Provisional application No. 61/816,607, filed on Apr. 26, 2013.

(51) Int. Cl. G06Q 30/02; G06Q 30/06

(52) U.S. Cl. CPC G06Q 30/0273; G06Q 30/0621
USPC 705/14.69

(57) ABSTRACT

A method of monetizing web site avatar customization by executing computer-executable instructions stored on a non-transitory computer-readable medium provides the user of a website with a digital avatar. The user may customize the digital avatar with various clothing or food items or other aspects, some of which are associated with the brand of an advertising affiliate. When the user chooses branded customizations for the avatar, the advertising affiliate associated with the brand chosen by the user is charged a fee, and the avatar is shown with the branded item displayed on the website, effectively making the avatar a platform for advertisement of the affiliate's brand.

The current application claims a priority to the U.S. Provisional Patent application Ser. No. 61/816,607 filed on Apr. 26, 2013.

### FIELD OF THE INVENTION

The present invention relates generally to internet web sites. More particularly, the present invention relates to a method for monetizing web sites through avatar customization.

### BACKGROUND OF THE INVENTION

Marketing is the process of communicating the value of a product or service to customers. Marketing is the link between a society's material requirements and its economic patterns of response. Marketing satisfies these needs and wants through exchange processes and building long term relationships. A significant aspect of marketing is advertising. Advertising is a form of communication for marketing that is used to encourage, persuade, or manipulate an audience (viewers, readers, or listeners) to continue an action or to take some new action. Most commonly, the desired result is to drive consumer behavior with respect to a commercial offering, although political and ideological advertising is also common. Advertising messages are usually paid for by sponsors and viewed via various traditional media, including mass media such as newspaper, newspaper, magazines, television, radio, outdoor advertising or direct mail, or new media such as blogs, other websites or text messages.

Commercial advertisers often seek to generate increased consumption of their products or services through branding, which involves associating a product name or image with certain qualities in the minds of consumers. The term “branding” was initially used to differentiate one person's cattle from another's by means of a distinctive symbol burned into the animal's skin with a hot iron stamp, and was subsequently used in business, marketing and advertising. A brand, according to the American Marketing Association Dictionary, is a “name, term, design, symbol, or any other feature that identifies one seller's good or service as distinct from those of other sellers.”

In computing, an avatar is a graphical representation of the user or the user's alter ego or character. An avatar may take a three-dimensional form (displayed two-dimensionally on a computer screen) or a two-dimensional form as an icon in internet forums and other online communities.

Many businesses own and run a website, and for some, the website is the core of the business. Websites have costs associated with running them, including paying for a domain and server space, depending on the application. A very common practice among website administrators is to display advertising somewhere on their pages. These advertisements vary in how they earn money for the site. The most common models for website advertising purchasing are payments per a certain number of times an advertisement is loaded, payments for each time a visitor clicks on an advertisement, and payment per action such as a purchase or registration. However, a method for generating revenue on a website by allowing users to customize a personal character avatar is not currently in existence.

It is therefore an object of the present invention to provide a method for monetizing internet websites through third-party advertising on customizable personal avatars.

### BRIEF DESCRIPTION OF THE DRAWINGS

FIG. 1 is a stepwise flow diagram describing the overall process of the present invention.

FIG. 2 is a stepwise flow diagram describing the process for registering a new user account.

FIG. 3 is a stepwise flow diagram describing methods for purchasing avatar customizations using digital currency.

FIG. 4 is a stepwise flow diagram describing the process for managing advertising options.

FIG. 5 is a stepwise flow diagram describing the process for charging the advertising affiliate for branded avatar customization selections.

FIG. 6 is another stepwise flow diagram describing the overall process of the present invention.

FIG. 7 is a block diagram describing connections between various parties in the preferred embodiment of the present invention.

### DETAIL DESCRIPTIONS OF THE INVENTION

All illustrations of the drawings are for the purpose of describing selected versions of the present invention and are not intended to limit the scope of the present invention.

The present invention is a method for generating revenue on an internet website by allowing a user or users of the website to create and customize a personal avatar with third party advertising brands. An avatar is a graphical representation of the user. In the preferred embodiment of the present invention, a user's avatar takes the form of a two-dimensional representation of a three-dimensional person or other creature. The present invention may be utilized on any website, and is intended to be utilized on websites which have a large amount of traffic. In the preferred embodiment of the present invention, an avatar takes the appearance of a human body, though in alternate embodiments, an avatar may take a different appearance, such as, but not limited to, an animal, an insect, a fictional creature, or a specific fictional or nonfictional human character. In general, the use of avatars in the present invention is for display only, with no functionality being associated with the avatars. The primary unique feature of the present invention is the aspect of monetizing the customization of digital avatars through third-party advertising with the avatar customizations.

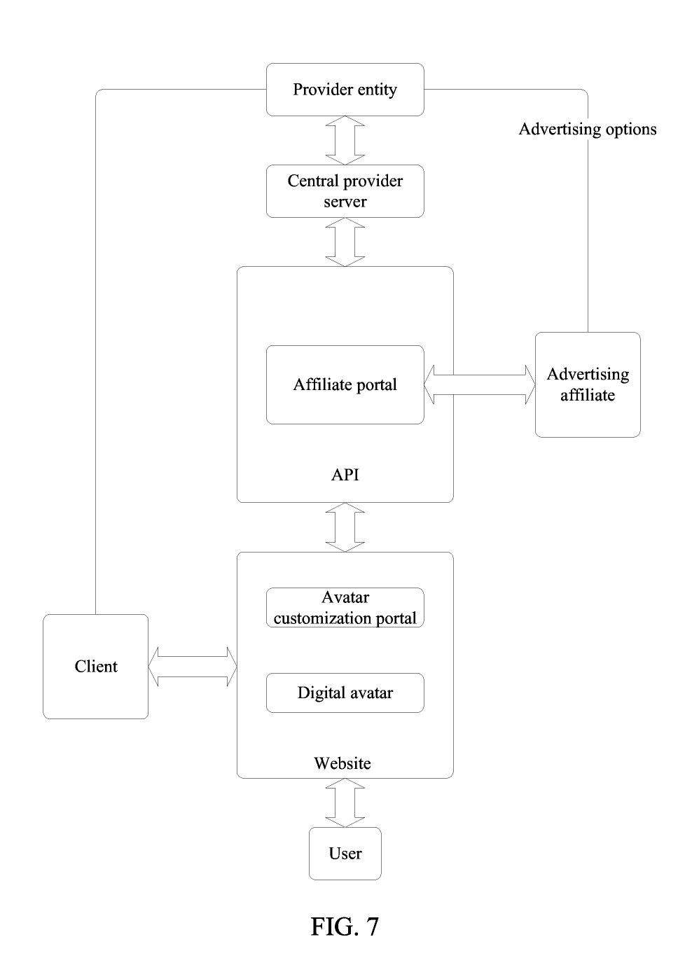

Referring to FIG. 7, in the preferred embodiment of the present invention, an application programming interface (API) is provided to a client. The client is a person or other entity that owns and/or operates a website. The API is a digital protocol intended to be used as an interface by software components to communicate with each other. In this case, the API allows the client to interface with a central provider server that stores data regarding avatars and provides the avatar data in order for avatars to be displayed on a website. In the preferred embodiment of the present invention, the central provider server is operated by a provider entity and acts as a hub that handles all digital avatars created and customized on all websites that utilize the present invention. The API provides the client and/or multiple users of the website with the ability to create, customize and display an avatar on the client's website. The avatar may be displayed anywhere on the website, at the client's discretion. The present invention may be used to provide a single avatar to the client, or to provide avatars to a plurality of users of the client's website. For example, the client may be a single person operating a weblog. In this case, the client and the user are synonymous. The client customizes a single personal avatar and embeds a portion of code into the source code of their weblog that causes their avatar to be displayed on the weblog. Alternatively, a plurality of users on a website may create and customize personal avatars, which may be displayed in association with the user's profile on the website, such as on an internet forum, or in an online multiplayer game format.

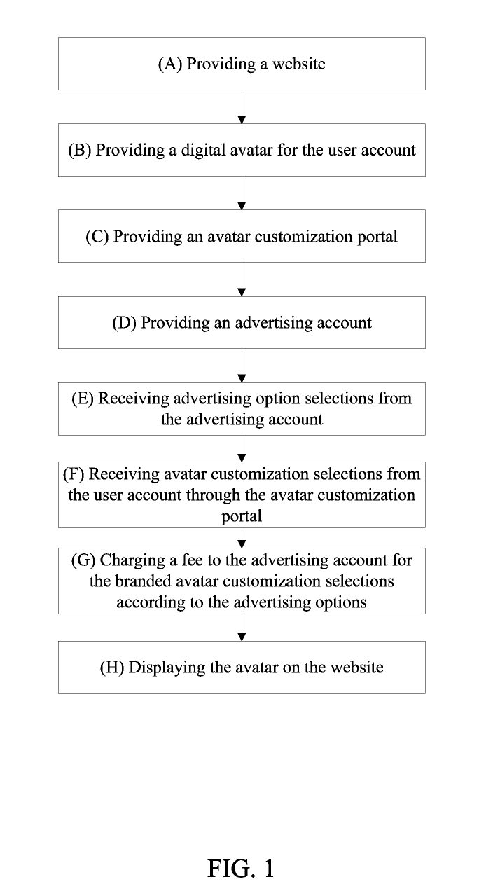

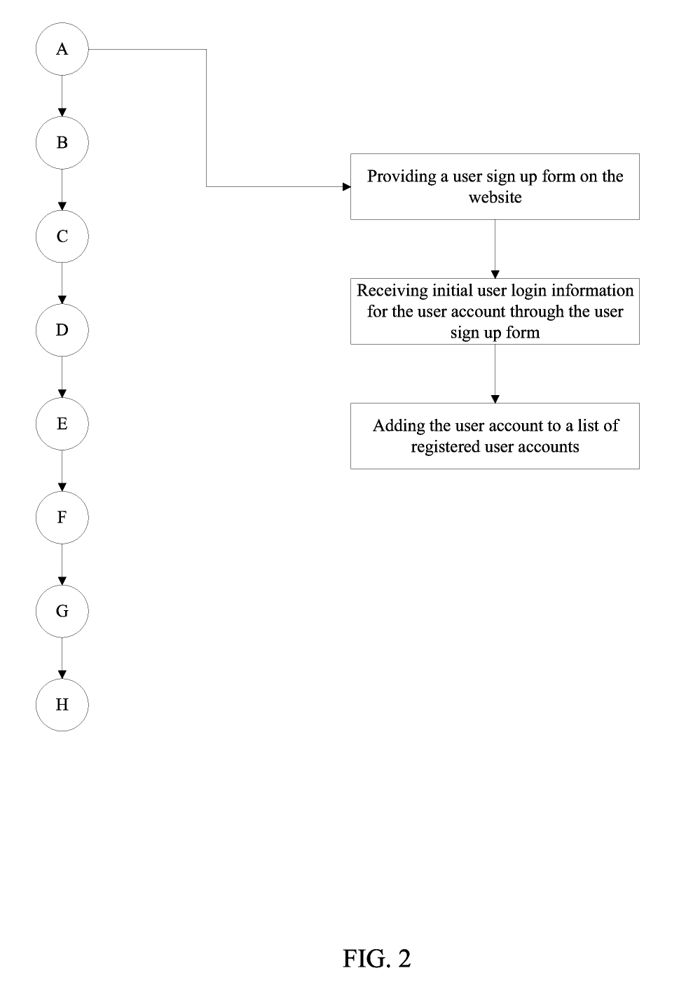

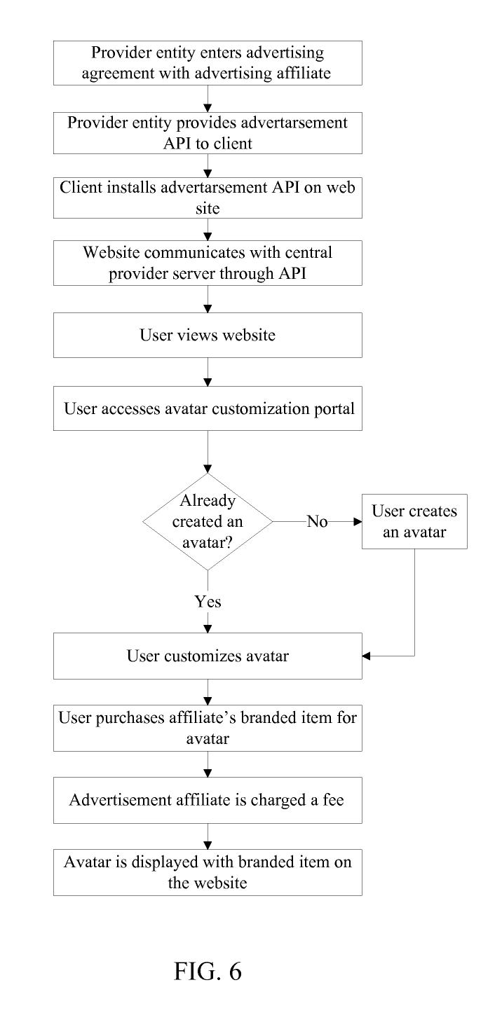

Referring to FIGS. 1 and 6, the general process of the present invention is as follows. A website is provided, wherein a user interacts with the website with a user account. As shown in FIG. 2, in one embodiment, a user sign up form is provided on the website. Initial user login information for the user account is received through the user sign up form, and the user account is added to a list of registered user accounts. A digital avatar is provided for the user account, wherein the digital avatar is a digital visual representation of the user.

In order to customize the digital avatar, the user accesses an avatar customization portal provided on the website. The user manages the digital avatar through the avatar customization portal with the user account. In the preferred embodiment of the present invention, the avatar customization portal is opened by clicking on the digital avatar, which preferably opens a pop-up window containing an interface for the avatar customization portal. In an alternate embodiment, the avatar customization portal is accessed by clicking a “Go to avatar store” link or a similar link provided to only the client.

When the avatar customization portal is displayed on the website for the user to customize the digital avatar, the digital avatar is initially displayed on the avatar customization portal with initial avatar aspects. The digital avatar is preferably displayed in an avatar display window. In the preferred embodiment of the present invention, if the user has not already initially set up the digital avatar, the user is prompted to select initial avatar aspects such as, but not limited to, selecting among preset characteristics such as being male or female. A plurality of avatar templates may also be provided for the user to choose among.

After initial avatar setup, the user is prompted to select new avatar aspects from a plurality of avatar customization options, wherein the plurality of avatar customization options includes branded customization selections. In the preferred embodiment of the present invention, the avatar customization portal displays a list of customization categories. The customization categories allow a user to customize particular aspects of the digital avatar, choosing from among several individual items within a customization category. For example, the user may select the “Pants” category, and is then presented with several different varieties of pants, from which the user may choose one pair of pants to display on the digital avatar. The user may also be presented with a variety of pre-made customizations or themes that can be assigned to the digital avatar. Such themes may include, but are not limited to, formal, lounge, trendy, seasonal, nightlife, safari, vacation, or any other theme.

The plurality of avatar customization options may include a wide variety of clothing, accessories, bodily features, and other items and customizable avatar characteristics. The plurality of avatar customization options may include, but is not limited to, lower body garments such as pants, shorts, or skirts, upper body garments such as t-shirts, vests, jackets, or blouses, glasses, headwear such as a hat, visor or other headgear, footwear such as shoes or sandals, tattoos, bodily features such as hair color, hairstyle, body proportions, facial hair, and accessories such as earrings, necklaces, rings, other jewelry, or watches. The user may also be provided with the option to change the color of one or more avatar customizations applied to the digital avatar—for example, the user may have the option to apply a custom color to a particular shirt. The user may also choose additional items to display with the avatar such as food or drink, sporting equipment such as a baseball bat, basketball, soccer ball, or skateboard, or other items such as a cell phone, music player, musical instrument, book, or a pet.

In the preferred embodiment of the present invention, when a user selects a new avatar customization option in the avatar customization portal, the digital avatar is instantly updated in the avatar display window with the new avatar customization. Options for customization operations available to the user preferably include, but are not limited to, an option to remove all customizations from the avatar, and an option to undo the new avatar customization and revert the digital avatar to the initial avatar aspects. The digital avatar is not displayed on the website with the new avatar customization until the user selects an option to save the current appearance of their avatar. Once the user saves the current appearance of the avatar, the new avatar customization is displayed on the user's avatar throughout the duration of the digital avatar's use, or until the user selects another new avatar customization.

Avatar customization options applied to the digital avatar are displayed on the digital avatar on the website. For example, a user may select a soda with the avatar customization portal, and then their avatar may be shown holding or drinking the soda. In another example, a user may purchase a hat, and the user's digital avatar will then be shown wearing the hat. Once the new avatar aspect selections are received through the avatar customization portal, the new avatar aspects are applied to the digital avatar so that the new avatar aspects override the initial avatar aspects. The digital avatar is then displayed on the website with the new avatar aspects.

The primary method by which the present invention monetizes websites through avatar customization is through third-party advertising, which may be known as “advertarsing.” Avatar customizations available through the avatar customization portal may generally be associated with a specific brand or product. The avatar customization portal may provide branded avatar customization options so that the digital avatar is displayed on the website with specifically branded items such as, but not limited to, clothes such as Guess jeans, a Ralph Lauren jacket, and Brooks Brothers shoes, or food or drink items from Pepsi, Budweiser or McDonalds. These items may be called avatars for their respective companies and are displayed on the digital avatar, hence the name, “advertarsing,” which is a combination of the words “avatar” and “advertising.”

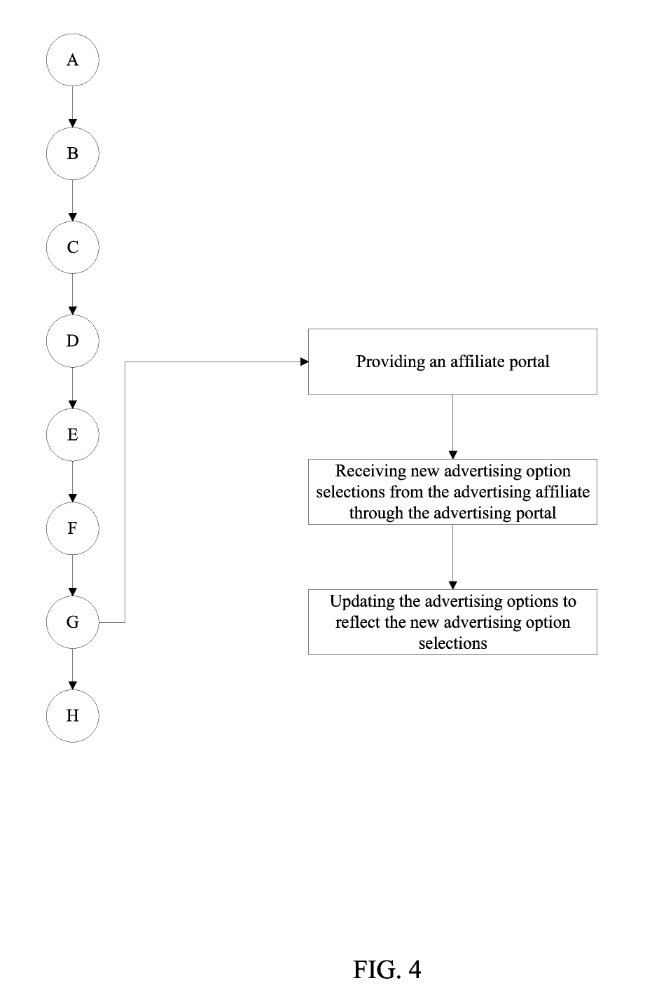

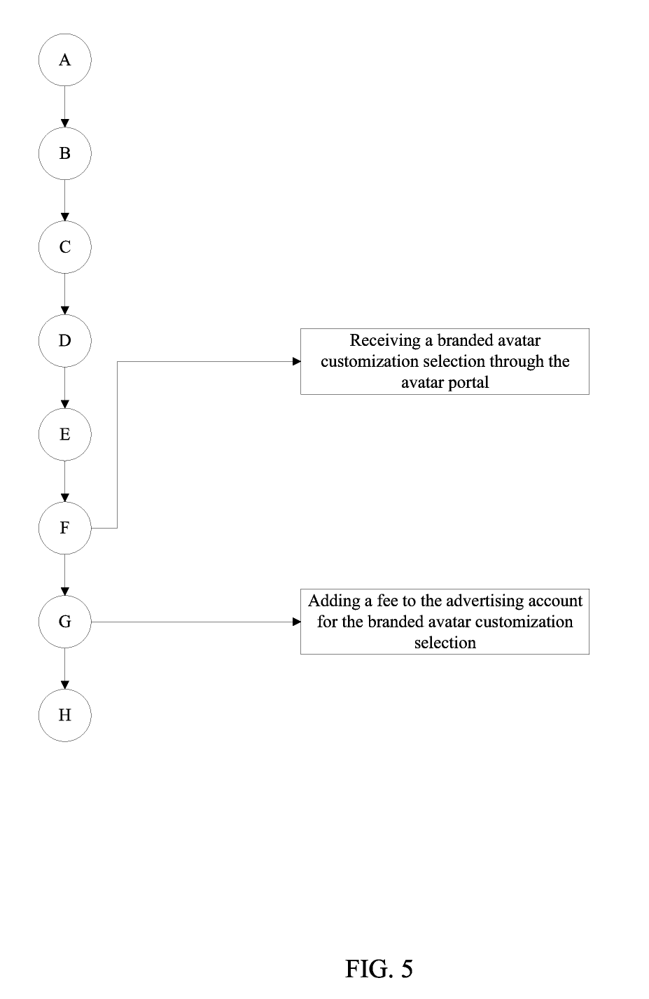

Advertarsing is accomplished according to the preferred embodiment of the present invention as follows. Each branded avatar customization option is associated with an advertising affiliate. Referring to FIG. 4, the advertising affiliate manages advertising options though an affiliate portal which is accessed by an advertising account. Both the affiliate portal and the advertising account are provided by the website. The advertising affiliate should enter into an advertising agreement with the central provider or otherwise select advertising options. As shown in FIG. 5, avatar customization selections are received from the user account through the avatar customization portal, wherein the avatar customization selections include branded avatar customization selections. A fee is charged to the advertising account for the branded avatar customization selections according to the advertising options, and the digital avatar is displayed on the website along the branded avatar customization selections being displayed on the digital avatar.

In one embodiment of the present invention, all of the avatar customization options are available to be chosen by the user to apply to the digital avatar at all times. In another embodiment, the user must complete various actions or other goals in order to unlock new customizations. In another embodiment, some or all of the avatar customizations have a price and must be purchased with digital currency.

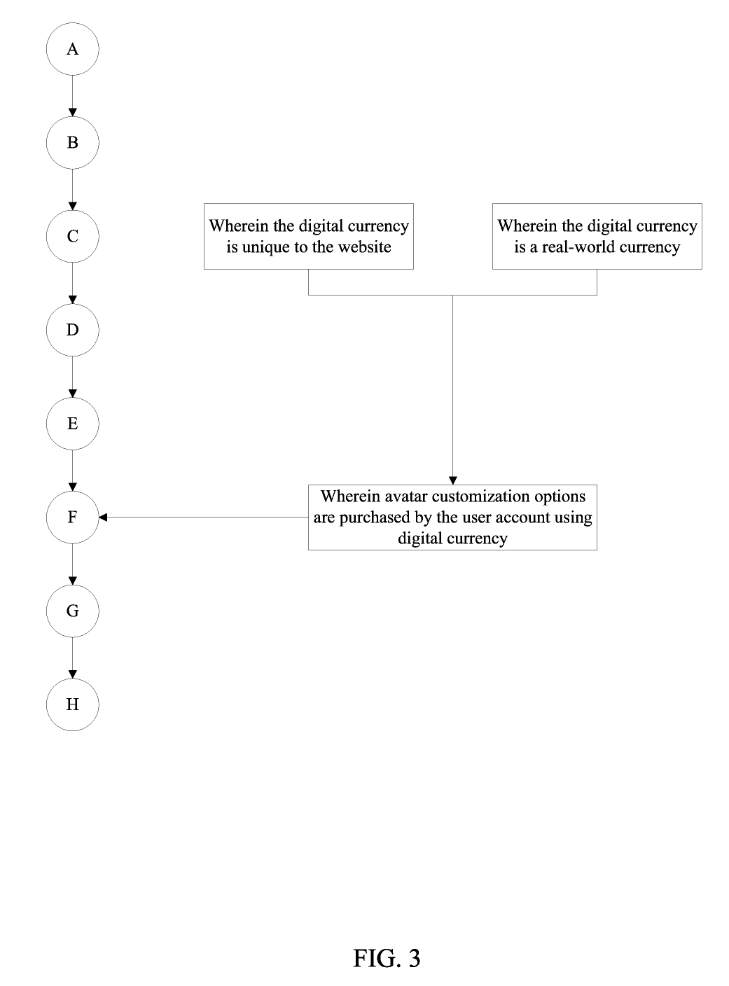

As shown in FIG. 3, in one embodiment, the digital currency is unique to the website. In this embodiment, the digital currency may be earned by completing certain actions such as, but not limited to, playing a certain number of games, earning a certain amount of score in a game, or earning digital currency by referring new users. For example, the website may be primarily focused on providing an online game that multiple users may play against each other, such as poker, with a visual depiction of a poker table being displayed on the website and each user being represented by their respective digital avatar being seated around the poker table. Users may purchase customizations with poker credits as the digital currency, or the digital currency may be earned in other ways. In another embodiment, the digital currency is real-world currency, or is bought with real-world currency. For example, the user may have to purchase amounts of digital currency using a credit card, or may directly purchase avatar customizations using the credit card.

One feature comprised in the preferred embodiment of the present invention is an option to purchase additional items that are not initially provided in the avatar store. The additional items may include any manner of items or other customizations, but preferably include customizations that are likely to entice a user to purchase additional customizations, such as good-looking clothes, higher quality brands, flashy items, or rare items. This is another method by which the present invention monetizes avatar customization. Additional customizations may be combined and sold in packages, or may be purchased individually.

The advertising affiliate chooses advertising options for the advertising account. Advertising options may include, but are not limited to, different advertisement types, advertising packages, and payment options. For example, the advertising affiliate may manage whether advertising is done with pay-per-click (PPC) advertisements, pay-per-view (PPV) advertisements, or a different type of advertisement. The advertising affiliate may preferably select new advertising options at any time, or advertising options may be subject to review or to contracts. New advertising option selections are received from the advertising affiliate through the advertising portal. The advertising options are then updated to reflect the new advertising option selections.

To additionally illustrate advertising options available to the advertising affiliate, an advertising package scheme is hereinafter described. A “Gold Package” charges the advertising affiliate $0.25 each time a user selects a branded avatar customization associated with the advertising affiliate to be displayed on the user's digital avatar. A “Platinum Package” charges the affiliate $0.35 each time a user selects a branded avatar customization associated with the advertising affiliate, and additionally shows a 10-second video advertisement to the user. A “Premium Package” charges the advertising affiliate $0.50 each time a user selects a branded avatar customization associated with the advertising affiliate, in addition to capturing the user's email address and sending a one-time email offer to the user's email address. The email offer is preferably determined by the advertising affiliate and approved by the provider entity. An email only package captures the user's email address and unique internet protocol (IP) address when a user selects a branded avatar customization associated with the advertising affiliate and allows email offers to be sent to the user at the cost of $0.05 per email. A “Product Placement Package” provides the maximum exposure for an advertising affiliate's brand. Users are allowed to register to play a game against each other, with the winner of the game receiving an item or offer of the advertising affiliate's choice. Users will compete for up to 8 hours, and all contestants will receive an email advertisement and/or a coupon for their participation in the event. The advertising affiliate is charged $0.10 per user registration in the Product Placement Package.

In the preferred embodiment of the present invention, the affiliate is provided with several features in the affiliate portal for managing advertising options. The affiliate portal preferably includes, but is not limited to, an affiliate overview section, a product overview section, and sections for managing the affiliate's advertising campaigns, managing advertising videos, managing advertising banners, managing payments and budgets, and viewing a plurality of statistical reports. The statistical reports may include, but are not limited to, total product sales, number of active advertising campaigns, active products, active video advertisements, active banners, number of ad views, number of product clicks, number of video clicks, and number of banner clicks, in a plurality of different time frames including the current day, current week, current month, and all time. The affiliate may choose what products to make available with the present invention, how payments are made to the provider company, and what specific or additional advertising methods are provided to the affiliate, among other aspects and advertising options.

Although the invention has been explained in relation to its preferred embodiment, it is to be understood that many other possible modifications and variations can be made without departing from the spirit and scope of the invention as hereinafter claimed.

What is claimed is:

1. A method of monetizing web site avatar customization by executing computer-executable instructions stored on a non-transitory computer-readable medium comprises the steps of:
providing a website,
wherein a user account interacts with the website;
providing a digital avatar for the user account, wherein the digital avatar is a digital visual representation of a user;
providing an avatar customization portal, wherein the user account manages the digital avatar through the avatar customization portal;
providing an advertising account,
wherein the advertising account is managed by an advertising affiliate;
wherein the advertising affiliate chooses advertising options for the advertising account;
receiving avatar customization selections from the user account through the avatar customization portal,
wherein the avatar customization selections include branded avatar customization selections;
wherein the branded avatar customization selections are associated with the advertising affiliate;
charging a fee to the advertising account for the branded avatar customization selections according to the advertising options; and
displaying the avatar on the website.

2. The method of monetizing web site avatar customization by executing computer-executable instructions stored on a non-transitory computer-readable medium as claimed in claim 1 comprises the steps of:
providing a user sign up form on the website;
receiving initial user login information for the user account through the user sign up form; and
adding the user account to a list of registered user accounts.

3. The method of monetizing web site avatar customization by executing computer-executable instructions stored on a non-transitory computer-readable medium as claimed in claim 1 comprises the steps of:
displaying the avatar customization portal on the website, wherein the digital avatar is displayed on the avatar customization portal with initial avatar aspects;
prompting to select new avatar aspects from a plurality of avatar customization options, wherein the plurality of avatar customization options includes branded customization items;
receiving the new avatar aspect selections through the avatar customization portal;
applying the new avatar aspects to the digital avatar, wherein the new avatar aspects override the initial avatar aspects; and
displaying the digital avatar on the website with the new avatar aspects.

4. The method of monetizing web site avatar customization by executing computer-executable instructions stored on a non-transitory computer-readable medium as claimed in claim 3, wherein avatar customizations options are purchased using digital currency.

5. The method of monetizing web site avatar customization by executing computer-executable instructions stored on a non-transitory computer-readable medium as claimed in claim 4, wherein the digital currency is unique to the website.

6. The method of monetizing web site avatar customization by executing computer-executable instructions stored on a non-transitory computer-readable medium as claimed in claim 4, wherein the digital currency is a real-world currency.

7. The method of monetizing web site avatar customization by executing computer-executable instructions stored on a non-transitory computer-readable medium as claimed in claim 1 comprises the steps of:
providing an affiliate portal, wherein the advertising affiliate manages the advertising account through the affiliate portal;
receiving new advertising option selections from the advertising affiliate through the affiliate portal,
wherein the new advertising options include advertisement types, advertising packages, and payment options; and
updating the advertising options to reflect the new advertising option selections.

8. The method of monetizing web site avatar customization by executing computer-executable instructions stored on a non-transitory computer-readable medium as claimed in claim 1 comprises the steps of:
receiving a branded avatar customization selection through the avatar portal,
wherein the branded avatar customization selection is associated with the advertising affiliate; and
adding a fee to the advertising account for the branded avatar customization selection.

9. A method of monetizing web site avatar customization by executing computer-executable instructions stored on a non-transitory computer-readable medium comprises the steps of:
providing a website,
wherein a user account interacts with the website;
providing a digital avatar for the user account, wherein the digital avatar is a digital visual representation of a user;
providing an avatar customization portal, wherein the user account manages the digital avatar through the avatar customization portal;
providing an advertising account,
wherein the advertising account is managed by an advertising affiliate;
wherein the advertising affiliate chooses advertising options for the advertising account;
displaying the avatar customization portal on the website, wherein the digital avatar is displayed on the avatar customization portal with initial avatar aspects;
prompting to select new avatar aspects from a plurality of avatar customization options, wherein the plurality of avatar customization options includes branded customization items;
receiving a branded avatar customization selection from the user account through the avatar customization portal,
wherein the branded avatar customization selections are associated with the advertising affiliate;
adding a fee to the advertising account for the branded avatar customization selection; and
displaying the avatar on the website.

10. The method of monetizing web site avatar customization by executing computer-executable instructions stored on a non-transitory computer-readable medium as claimed in claim 9 comprises the steps of:
providing a user sign up form on the website;
receiving initial user login information for the user account through the user sign up form; and
adding the user account to a list of registered user accounts.

11. The method of monetizing web site avatar customization by executing computer-executable instructions stored on a non-transitory computer-readable medium as claimed in claim 9 comprises the steps of:
receiving the new avatar aspect selections through the avatar customization portal;
applying the new avatar aspects to the digital avatar, wherein the new avatar aspects override the initial avatar aspects; and
displaying the digital avatar on the website with the new avatar aspects.

12. The method of monetizing web site avatar customization by executing computer-executable instructions stored on a non-transitory computer-readable medium as claimed in claim 11, wherein avatar customizations options are purchased using digital currency.

13. The method of monetizing web site avatar customization by executing computer-executable instructions stored on a non-transitory computer-readable medium as claimed in claim 12, wherein the digital currency is unique to the website.

14. The method of monetizing web site avatar customization by executing computer-executable instructions stored on a non-transitory computer-readable medium as claimed in claim 12, wherein the digital currency is a real-world currency.

15. The method of monetizing web site avatar customization by executing computer-executable instructions stored on a non-transitory computer-readable medium as claimed in claim 9 comprises the steps of:
providing an affiliate portal, wherein the advertising affiliate manages the advertising account through the affiliate portal;
receiving new advertising option selections from the advertising affiliate through the affiliate portal,
wherein the new advertising options include advertisement types, advertising packages, and payment options; and
updating the advertising options to reflect the new advertising option selections.
